(19) United States
(12) Patent Application Publication
(10) Pub. No.: US 2003/0049984 A1
(43) Pub. Date: Mar. 13, 2003

(54) Electro-static dissipative clean room wiper

(76) Inventors: H. Graham Tucker JR., LaGrange, GA (US); Andrew C. Child, Moore, SC (US); Creighton Kelly, LaGrange, GA (US); Kevin R. Brown, Spartanburg, SC (US)

Correspondence Address: Milliken & Company, P.O. Box 1927, Spartanburg, SC, 29304, US

(21) Appl. No.: 09/945,070

(22) Filed: Aug. 31, 2001

(51) Int. Cl. B32B 5/02; B32B 3/00; B32B 9/00

(52) U.S. Cl. 442/59

(57) ABSTRACT

A process for the manufacture and treatment of wiping cloths for use in a cleanroom, or another similar controlled environment, the construction and treatment being such that the wipers do not release contaminating particles into the controlled environment, and have electrostatic dissipative properties.

### BACKGROUND OF THE INVENTION

The present invention relates generally to the prevention of particulate contamination and static electricity build-up in cleanrooms and other clean environments. More specifically, the present invention is directed to the construction and treatment of wipers for use in a cleanroom, or another similar controlled environment, the construction and treatment being such that the wipers do not release contaminating particles into the controlled environment, and have electrostatic dissipative properties.

Cleanrooms are finding wider use in the manufacture, inspection and maintenance of precision products where it is essential that various operations be conducted in an environment as free of undesired small particles as possible. Similarly, it is becoming increasingly clear that the manufacture of such precision products also requires a generally static-free environment. Cleanrooms can function effectively only when every effort is taken to maintain the close control necessary to preclude particulate and electro-static contamination of the controlled environment within the cleanroom. Such contamination most often is generated by the worker in the cleanroom and by items brought into the cleanroom. Rigorous standards have been established, and continue to be developed, for the operation of cleanrooms in such a manner as to exclude unwanted contaminants and electro-static build-up from the controlled environment. For example, computer hardware manufacturing facilities are implementing such measures as air ionization controls to balance the positive and negative ions within the room, as well as personal grounding straps and wrist bands that are worn by workers to reduce tribo-charging.

One potential source of particulate contamination and electro-static build-up in cleanrooms has been the wipers used extensively in connection with operations carried out in the controlled environment of a cleanroom. For example, in the fabrication of semiconductor chips, wipers are used for cleaning up spills that can occur during the procedures carried out in the controlled environment of a cleanroom. In addition, wipers are used for wiping surfaces of various equipment and items in the cleanroom, as well as for wiping down the walls and workspaces within the cleanroom itself.

Currently, there are several types of cleanroom wipers and electro-static dissipative (ESD) wipers on the market. However, typically the ESD wipers are not clean enough to be used in a cleanroom, and the actual cleanroom wipers generally do not display a high level of electro-static dissipative properties to be useful in such applications. As used herein, the term electro-static dissipative wipers refers to wipers having surface resistivity of less than 10¹⁰ ohms/square.

Attempts have been made to manufacture this ESD wiper product by first polymerizing the ESD chemistry on polyester fabric in wide width (65-inch) form in a textile jig. This method will be referred to herein as the “Jig method.” A jig is a device that contains a bath of a desired volume of chemicals whereby wide width fabric is passed through the bath multiple times by means of a dual winder assembly and series of tensioning rollers. The wet fabric is dried with a textile tenter frame. A tenter frame is a device that holds the wet fabric in a flat form by means of a chain containing either pins or clips to hold the fabric in place as it is passed continuously through a series of chambers containing forced air heated to a specified temperature (i.e. gas fired, infra-red, etc.). 9-inch×9-inch wipers are cut from this finished fabric using a heat source, which may be used for cutting and sealing or fusing the edges. The cut wipers are then cleanroom laundered and packed for customer use. The disadvantage to this approach is that the edges of the wipers, after laundering, are not consistently sealed due to the ESD treated fabric absorbing some of the cutting energy of the heat source. The absorbtion of some of the heat source energy by the fabric leads to rough edges and excessively high temperatures. To solve this problem, using heat for cutting and sealing the edges was abandoned in favor of knife cutting, which solved the high temperature problem, but still resulted in rough edges. Rough edges tend to produce high levels of particulate matter when the wipers are used, which is unacceptable in a cleanroom environment.

The Texwipe Company L.L.C. currently manufactures an ESD cleanroom wiper consisting of a 100 percent nylon base fabric. The Texwipe ESD cleanroom wiper is extremely high (>9700 fibers per square meter) in fiber count per square meter (≧100 microns in size), as measured by the Fiber Analysis and Particle Counting Test as specified by ASTM F311-F312.

Milliken and Company currently manufactures an electrostatic dissipative (ESD) wiper that includes a series of carbon yarns knitted into the body of the fabric used to produce the wiper. The static dissipative characteristic is not uniform across the entire surface of the wiper. Only when contact is made across the carbon yarn is the charge dissipated.

Thus, it would be desirable to provide a wiper that was both clean enough to use in the cleanroom environment, but that would also exhibit acceptable ESD properties across the entire wiper as well. It would also be desirable to provide a process to produce such a wiper.

### OBJECTS OF THE INVENTION

Accordingly, it is an object of the present invention to provide a wiper construction and treatment that will reduce particulate and electro-static contamination released from the wiper during use thereof.

It is another object of the present invention to provide a wiper that eliminates the release of unwanted particles and electrostatic energy into a cleanroom, while enabling effective and efficient wiping procedures.

Yet another object of the present invention is to provide a method for manufacturing and chemically treating a wiping cloth so that it may be both clean enough and electrostatically neutral enough to be used in a cleanroom environment.

Still another object of the present invention is to provide the low particulate release and ESD properties, while still retaining the desired pliability and absorbency characteristics in wipers employed in controlled environments, such as in cleanrooms.

Another object of the present invention is to provide a strong, durable wiper that is manufactured from commonly available materials, thereby enabling economy of manufacture and use while eliminating a source of particulate and electrostatic contamination.

The above objects and advantages, as well as further objects and advantages, are attained by the present invention, which may be described briefly as a wiper for reducing particulate and electrostatic contamination which otherwise might result from the use of the wiper in a controlled environment, such as that maintained in a cleanroom.

### DETAILED DESCRIPTION

An electrostatic dissipative cleanroom wiper is manufactured through the use of washwheel applied polymerized pyrrole chemistry to achieve electrostatic dissipative characteristic uniformly across the entire surface of the wiper. Preferably, the wiper is made from continuous filament knit polyester. This method will be referred to herein as the “Washwheel method.”

The wiping cloth fabric is made from continuous filament circular knit polyester fabric, and is then cut into individual wipers, preferably using a laser-cutting device. The wipers are placed into the inside drum of a washwheel to undergo the process of pyrrole polymerization for the purposes of rendering the wipers electrostatically dissipative. A washwheel device consists of a large cavity capable of holding liquid with a large rotating drum located inside of the cavity, similarly to a clothes washing machine. The drum can be rotated at various revolutions per minute for agitation purposes and extraction of liquid purposes. The drum can be loaded with wipers and/or various other materials. The washwheel cavity has hot, cold and ultrapure water inflow capability and drain outflow capability. There is a chemical addition port, where various chemicals can be introduced into the cavity for the purposes of changing the characteristics of the contents of the drum inside of the washwheel cavity.

The general manufacturing process includes the steps of running the untreated fabric through a laser-cutting device, which produces a plurality of wiping cloths, where each wiping cloth preferably has sealed or fused borders on the edges thereof. The sealed or fused edges serve to capture loosened filaments and particulate matter that may have been produced during the cutting process, to prevent them from dislodging from the wiper. Although laser-cutting is the preferred cutting method, it is to be understood that any suitable cutting method may be used, including such methods as ultrasonic cutting or knife cutting. The next step is to place the cut wiping cloths into a washwheel or similar device, and to run the wiping cloths through a cleaning and rinsing cycle to remove dirt, oils, or other contaminants. It may be necessary to run the wiping cloths through several cleaning and rinsing cycles before moving to the next step. The remaining liquid is drained after the rinsing cycle, and then ESD enhancing chemicals are added to the washwheel, together with water. The washwheel then runs through an agitation cycle with the ESD enhancing chemicals, the wipers, and the water for a sufficient time to saturate the wipers with the chemicals. The liquid is then drained, and the wipers are run through a rinse cycle in the washwheel. The wipers are then removed from the washwheel and placed into a dryer for a drying cycle. Then the wipers are cooled.

This process allows treatment of many different types of wiping cloths, including wipers having sealed edges, wipers having fused borders, wipers having a combination of sealed edges and fused borders, or any other types of wiping cloths. A sealed edge is defined as an edge where the ends of the cut fibers have been heated to a temperature above the melting point of the fibers and then cooled, in order to prevent release of the cut fibers from the edge of the wiping cloths. A fused border is simply an extension of the sealed edge of the wiping cloth, where a border around the edge has been fused by applying heat inwardly from the edge of the wiping cloth some distance sufficient to capture the loose fibers of a cut fabric, in order to prevent their release.

A more specific example of the process for utilizing the washwheel to apply the polymerized pyrrole chemistry to the wiping cloths is as follows:

### EXAMPLE 1

| | Process Step | Time |
|---|---|---|
| 1. | Weigh 30 g cleansing agent (alkylarylsulfonate | 2 mins |
| | surfactant) and add 400 ml H₂O to jar | |
| 2. | Weigh 7.7 Kg wipers (5 buckets × 1540 g) | 13 mins |
| 3. | Load 35 lb Milnor washwheel | 3 mins |
| 4. | Wash with surfactant solution (high level) (130° F.) | 5 mins |
| 5. | Drain and Extract | 2 mins |
| 6. | Rinse (high level) | 3 mins |
| 7. | Drain and Extract | 2 mins |
| 8. | Rinse (high level) | 3 mins |
| 9. | Drain and Extract | 2 mins |
| 10. | Weigh 447.87 g 35% Fe(NO₃)₃ in 3 jars | 5 mins |
| 11. | Weigh 70.8 g AQSA in jar and add 900 ml H₂O | 2 mins |
| 12. | Add 2500 ml of H₂O to each of jars in step 10 | 3 mins |
| 13. | Add 300 ml from step 11 to each jar from step 12 to | 2 mins |
| | dissolve | |
| 14. | Begin fill of washwheel (low level) | 1 mm |
| 15. | Add Fe(NO₃)₃ / AQSA solution to washwheel during | 2 mins |
| | fill | |
| 16. | Allow Fe(NO₃)₃ / AQSA solution to wet wipers in | 5 mins |
| | washwheel | |
| 17. | Add pyrrole | 1 min |
| 18. | Run washwheel | 60 mins |
| 19. | Drain and Extract | 2 mins |
| 20. | Rinse (high level) | 3 mins |
| 21. | Drain and Extract | 2 mins |
| 22. | Rinse (high level) | 3 mins |
| 23. | Drain and Extract | 2 mins |
| 24. | Remove wipers from washwheel and dry for 15 mins | 15 mins |
| | at 160° F. | |
| 25. | Cool down wipers in dryer for 10 minutes | 10 mins |
| | Total Cycle Time = | 153 mins |

AQSA is Antraquinone-2-sulfonic acid, sodium salt. The preferred cleansing agent surfactant, listed in steps 1 and 4 above, is Rhodocal® BX-78, manufactured by Rhone-Poulenc, in Lawrenceville, Ga.

The chemically treated wipers are dried in a commercial dryer. The wipers are then cleanroom laundered using a washwheel and dryer that are set up to process goods in an ultraclean environment to yield a wiper having low particulate release and low fibril content.

Various tests were performed on several different ESD cleanroom wipers. The wipers tested include wipers manufactured by Milliken & Company using the Jig method, Milliken wipers manufactured using the Washwheel method, and ESD cleanroom wipers manufactured by The Texwipe Company, L.L.C. The Texwipe wiper is a static-dissipative wiper for ESD-sensitive electronics manufacturing, which is constructed of 100% continuous-filament knitted nylon.

TABLE 1

| | | Milliken | |
|---|---|---|---|
| MANUFACTURER | Milliken | 492233-836 | Texwipe |
| STYLE / PATTERN | 492233-836 | Washwheel | TX4025 |
| Manufacturing Method | Jig Method | Method | Current |
| LIQUID PARTICLES | | | |
| Biaxial Shake Test | | | |
| (IEST-RP-CC-004.2 SEC. 5.2) | | | |
| >0.5 μM million particles per m² | 48.0 | 12.3 | 12.89 |
| FIBER ANALYSIS | | | |
| ASTM F311-F312 | | | |
| >100 μM Fibers/m² | 1200 | 663 | 9792 |
| NONVOLATILE RESIDUE | | | |
| Short term Extraction | | | |
| (IEST-RP-CC-004.2 SEC. | | | |
| 6.1.2) | | | |
| Grams per m² | | | |
| DI Water | 0.0150 | 0.0129 | 0.60 |
| IPA | 0.1000 | 0.0674 | 0.16 |
| SORBENCY | | | |
| Rate & Capacity | | | |
| (IEST-RP-CC-004.2 SEC. | | | |
| 7.1 & 7.2) | | | |
| Rate - seconds | 5.0 | 1.0 | 3.5 |
| Capacity - ml per m² | 325 | 573 | 520 |
| ESD Test (Ohms / sq.) Surface | 10e8 | 10e6 | 6 × 10e7 |
| Resistivity Test (EOS/ESD - | | | |
| S11.11 - 1993) | | | |

IEST-RP-CC = Institute of Environmental Sciences and Technology - Recommended Practice - Contamination Control
EOS/ESD = Electrical Overstress / Electrostatic Discharge
ASTM = American Standards of Testing and Measurement

As can be seen from the table above, the Washwheel method provides a 45% fiber reduction over prior art on the body of the wiper as tested by ASTM F311- F312 Test Method. Also, the Washwheel method has been shown to provide a 33% reduction over prior art of Non Volatile Residue (grams/m²) in isopropyl alcohol as tested by IEST-RP-CC-004.2 SEC 6.1.2 Short Term Extraction. Further, the data shows a 70% improvement over prior art of Rate of Sorbency (seconds) as tested by IEST-RP-CC-004.2 SEC 7.1 Sorbency Rate Test. Finally, it should be noted that Surface Resistivity characteristics (ohms/square) of wipers treated by the Washwheel method have improved by an order of magnitude as tested by the EOS/ESD-S11.11-1993.

Although the present invention has been described in considerable detail with reference to certain preferred versions thereof, other versions are possible. Therefore, the spirit and scope of the appended claims should not be limited to the description of the preferred versions contained herein.

What is claimed is:

1. An electrostatic-dissipative cleanroom wiping cloth comprising:
a treated fabric substrate exhibiting exhibiting fiber analysis results of less than about 1200 fibers per square meter when measuring particles having a size greater than or equal to 100 microns, according to ASTM F311-F312.

2. The wiping cloth set forth in claim 1, wherein said fiber analyses results fall within the range of about 1200 to about 663 fibers per square meter when measuring particles having a size greater than or equal to 100 microns, according to ASTM F311-F312.

3. The wiping cloth set forth in claim 1, wherein said fabric substrate is polyester.

4. The wiping cloth set forth in claim 1, wherein said fabric includes at least one edge treated to produce a border selected from the group consisting of a fused border, a sealed border, or a combination thereof.

5. The wiping cloth set forth in claim 1, wherein said substrate has been treated with a polymerized pyrrole treatment.

6. The wiping cloth set forth in claim 1, wherein said wiping cloth exhibits a sorbency rate of below about 3.5 seconds, according to IEST-RP-CC-004.2 SEC. 7.1.

7. The wiping cloth set forth in claim 6, wherein said wiping cloth exhibits a sorbency rate of between about 3.5 seconds and about 1.0 second, according to IEST-RP-CC-004.2 SEC. 7.1.

8. The wiping cloth set forth in claim 1, wherein said wiping cloth exhibits non-volatile residue below about 0.0150 grams per square meter in deionized water as tested by IEST-RP-CC-004.2 SEC. 6.1.2.

9. The wiping cloth set forth in claim 1, wherein said wiping cloth exhibits non-volatile residue in the range of between about 0.0129 and about 0.0150 grams per square meter in deionized water as tested by IEST-RP-CC-004.2 SEC. 6.1.2.

10. The wiping cloth set forth in claim 1, wherein said wiping cloth exhibits non-volatile residue below about 0.1000 grams per square meter in isopropyl alcohol as tested by IEST-RP-CC-004.2 SEC. 6.1.2.

11. A method of manufacturing and treating wiping cloths to enhance electro-static dissipative properties, said method comprising the steps of:
providing a wiping cloth fabric substrate;
cutting said fabric substrate into individual wiping cloths;
cleaning and rinsing said wiping cloths;
applying electro-static dissipative enhancing treatment to said wiping cloths; and
drying said wiping cloths.

12. The method set forth in claim 11, wherein said steps of cleaning and rinsing said wiping cloths and applying said electro-static dissipative enhancing treatment to said wiping cloths are performed in a washwheel device.

13. The method set forth in claim 11, wherein said wiping cloths are made of polyester.

14. The method set forth in claim 11, wherein said cutting step is performed using a laser-cutting device.

15. The method set forth in claim 11, wherein said electro-static dissipative enhancing treatment comprises a chemical solution comprising pyrrole.

16. A wiping cloth comprising:
a pre-cut fabric substrate treated with polymerized pyrrole to enhance electro-static dissipative properties of said wiping cloth.

17. The wiping cloth set forth in claim 16, wherein said fabric includes polyester yarns.

18. The wiping cloth set forth in claim 16, wherein said fabric includes at least one edge treated to produce a border selected from the group consisting of a fused border, a sealed border, or a combination thereof.

19. The wiping cloth set forth in claim 16, wherein said wiping cloth exhibits a sorbency rate of below about 3.5 seconds, according to IEST-RP-CC-004.2 SEC. 7.1.

20. The wiping cloth set forth in claim 16, wherein said wiping cloth exhibits non-volatile residue below about 0.0150 grams per square meter in deionized water as tested by IEST-RP-CC-004.2 SEC. 6.1.2.

21. The wiping cloth set forth in claim 16, wherein said wiping cloth exhibits non-volatile residue below about 0.1000 grams per square meter in isopropyl alcohol as tested by IEST-RP-CC-004.2 SEC. 6.1.2.

22. The wiping cloth set forth in claim 16, wherein said wiping cloth exhibits electro-static surface resistivity in the range of about 1,000,000 to 60,000,000 ohms per square according to the Surface Resistivity Test (EOS/ESD - S11.11- 1993).

23. The wiping cloth set forth in claim 16, wherein said wiping cloth exhibits fiber analysis results of less than about 1200 fibers per square meter when measuring particles having a size greater than or equal to 100 microns, according to ASTM F311-F312.

24. A method of treating pre-cut wiping cloths to enhance electrostatic dissipative properties, said method comprising the steps of:
adding a cleansing agent, water, and wiping cloths into an agitation device;
washing said wiping cloths in said cleansing agent and water within said agitation device;
draining and extracting said water and said cleansing agent from said agitation device;
rinsing said wipers with water;
adding electrostatic dissipation enhancing chemicals to said agitation device
agitating said wipers and said electrostatic dissipation enhancing chemicals;
draining said electrostatic dissipation enhancing chemicals from said agitation device;
rinsing said wiping cloths with water; and
drying said wiping cloths.

25. The process set forth in claim 24, wherein said cleansing agent is an anionic surfactant.

26. The process set forth in claim 24, wherein said agitation device is a washwheel.

27. The process set forth in claim 24, wherein said electrostatic dissipation enhancing chemicals comprise a solution containing Fe(NO₃)₃, AQSA and pyrrole.

28. An electrostatic-dissipative cleanroom wiping cloth comprising:
a treated fabric substrate exhibiting fiber analysis results of less than about 1200 fibers per square meter when measuring particles having a size greater than or equal to 100 microns, according to ASTM F311 -F312, and also exhibiting a sorbency rate of below about 3.5 seconds, according to IEST-RP-CC-004.2 SEC. 7.1.

29. The wiping cloth set forth in claim 28, wherein said fabric substrate also exhibits electro-static surface resistivity in the range of about 1,000,000 to 60,000,000 ohms per square as measured by the Surface Resistivity Test (EOS/ESD - S11.11-1993).

30. The wiping cloth set forth in claim 28, wherein said wiping cloth exhibits non-volatile residue in the range of below about 0.0150 grams per square meter in deionized water as tested by IEST-RP-CC-004.2 SEC. 6.1.2.

31. The wiping cloth set forth in claim 28, wherein said wiping cloth exhibits non-volatile residue in the range of below 0.1000 grams per square meter in isopropyl alcohol as tested by IEST-RP-CC-004.2 SEC. 6.1.2.

32. The wiping cloth set forth in claim 28, wherein said fabric substrate is polyester.

33. The wiping cloth set forth in claim 28, wherein said fabric includes at least one edge treated to produce a border selected from the group consisting of a fused border, a sealed border, or a combination thereof.

34. The wiping cloth set forth in claim 28, wherein said substrate has been treated with a polymerized pyrrole treatment.
